(19) United States
(12) Patent Application Publication
(10) Pub. No.: US 2018/0264523 A1
(43) Pub. Date: Sep. 20, 2018

(54) A Method Of Cleaning Of A Printed Band Of Flexible Material, As Well As An Apparatus Therefor

(71) Applicant: BOERS HOLDING B.V., Nijkerk (NL)

(72) Inventors: Herman Van Kesteren, Rhenen (NL); Christiaan Mark Van Wijhe, Twello (NL)

(21) Appl. No.: 15/571,214

(22) PCT Filed: May 2, 2016
(86) PCT No.: PCT/NL2016/050316

§ 371 Date: Nov. 1, 2017

(30) Foreign Application Priority Data
May 1, 2015 (NL) 2014747

(51) Int. Cl. B08B 1/02; B08B 3/04; B08B 1/00; B08B 3/14; B65H 37/00; B65H 18/08; B41F 23/00; B41M 7/00

(52) U.S. Cl. CPC B08B 1/02; B08B 3/041; B08B 1/005; B08B 3/14; B08B 1/04; B65H 18/08; B41F 23/002; B41M 7/0009; B65H 37/00

(57) ABSTRACT

Method for cleaning a printed band (195) of flexible material, having printing ink at at least one side thereof and is stripped from the printing ink using an apparatus (100) which comprises a cleaning organ.) The method comprises
contacting the at least one side of the band (195) that comprises printing ink with a cleaning fluid (599),
removing the printing ink that has been contacted with the cleaning fluid (599) with the cleaning organ yielding a cleaned band (195′) of flexible material, and
removing adhering cleaning fluid (599) from the cleaned band (195) of flexible material;

For effective cleaning the printed band (195)
is guided into a bath (121) with cleaning fluid (599), and
is stripped from the printing ink in the bath (121) by means of the cleaning organ; and the cleaned band (195) is guided out off the bath (121) and stripped from the adhering cleaning fluid (599).

The present invention relates to method for cleaning a printed band of flexible material, wherein the band comprises printing ink at at least one side thereof and is stripped from the printing ink using an apparatus for cleaning the printed band of flexible material, which apparatus comprises a cleaning organ, and which method comprises the steps of
contacting the at least one side of the band that comprises printing ink with a cleaning fluid,
removing the printing ink that has been contacted with the cleaning fluid with the cleaning organ yielding a cleaned band of flexible material, and
removing adhering cleaning fluid from the cleaned band of flexible material.

When printing on a band of flexible material, generally a plastic film, unusable printed film will be produced when setting up the printing process. The setting up comprises the registration of colors for multicolor printing, and/or adapting a color until it has the desired hue. Since the conveying speed of the film past the printing machine is relatively high (e.g. 1 m/sec) and the setting up will take relatively long, large amounts of rejected printed film will ensue. It is known in the art to clean the printed band, for instance from U.S. Pat. No. 5,289,774.

A problem is that the cleaning may not be thoroughly enough, i.e. parts of the ink remain on the band.

The object of the present invention is to this reduce this problem.

To this end, method according to the preamble is characterized in that the printed band
is guided into a bath of cleaning fluid, and
is stripped from the printing ink in the bath by means of the cleaning organ yielding the cleaned band; and the cleaned band is guided from the bath and is stripped from the adhering cleaning fluid.

Guiding through a bath can achieve an intensive exposure to the cleaning fluid, and ink particles separated from the band can be brought into a relatively large volume of cleaning fluid. Thus, a more effective cleaning is achieved.

The cleaning organ may for instance be an ultrasonic cleaning organ or a scraping organ such as for instance a brush or a sponge roller. The removal of adhering cleaning fluid may include the use of various means, such as wiper blades, air knives, a drying chamber, or a combination thereof. The cleaning organ generally extends transverse to the length direction of the flexible band, in general across the whole width thereof.

Usually the cleaned band will be processed into granulate, yet preferably it will be re-used (be printed on again). For the latter, the cleaned band will be rolled up or optionally be fed directly to a printing press. For re-use as a printing film a drying step will be performed.

According to a favourable embodiment, the cleaning organ is a rotating scraping organ which rotates with a velocity that is coupled to the velocity with which the cleaned band exits the bath.

Thus, the velocity with which the scraping organ scrapes the surface of the printed band can be adapted and the film can also be sufficiently stripped from ink with higher conveyer speeds of the printed band. The coupling can be achieved by coupling the rotating scraping organ with a motor with which the printed band is fed through the bath, or by coupling the rotating scraping organ with a guide roll used for feeding the printed band through the bath. Herewith, a mechanical coupling can be used such as gear wheels, a chain or the like. Alternatively, the rotating scraping organ may be powered by a motor of its own, wherein the velocity is controlled depending on the conveying speed of the printed band.

According to a favourable embodiment, the direction of rotation of the rotating scraping organ is such that, at the location where the scraping organ is in contact with the printed band, it rotates against the direction of travel of the printed band.

Thus, the velocity with which the scraping organ moves across the surface of the printed band can be increased, thereby allowing the printed band to be stripped from ink in a better way.

According to a favourable embodiment, the printed band is cleaned with an apparatus comprising a frame and an auxiliary frame, which auxiliary frame
comprises at least one guide roll;
can be in a relatively high first position and a relatively low second position;
   wherein for cleaning the printed band
the printed band in the first position is introduced into the auxiliary frame, and
the auxiliary frame is put into the second position and the printed band, for the cleaning thereof, is fed through the auxiliary frame.

With the auxiliary frame in a relatively high position wherein the auxiliary frame sits partially or entirely above the bath and above the cleaning fluid present therein, the printed band can be easily introduced. The frame will comprise an actuator for feeding the the printed band through the apparatus. The first, leading portion of the printed band will not be cleaned. However, when a printed band is coupled (“splicing”, using tape such as known with printing film) to a following end from a printed band that yet at least partially has to be subjected to cleaning, this disadvantage is quite limited. Being able to move from the second position to the first position is also useful when maintaining, repairing and cleaning the apparatus and/or changing the fluid of the bath.

According to a favourable embodiment, the auxiliary frame comprises the cleaning organ.

Thus, the arrangement of the auxiliary frame in the bath is less critical, and the printed band can be cleaned effectively with increased reliability.

According to a favourable embodiment, the cleaning fluid in the bath is subjected to a filtration in order to remove ink particles.

Thus, the concentration of ink particles in the cleaning fluid is reduced and it may be used for longer before needs to be changed. Subjecting the fluid to a filtration is e.g. done by circulating the cleaning fluid through a filter, preferably continuously.

According to a favourable embodiment, the cleaning fluid in the bath is subjected to a distillation in order to obtain a cleaning fluid that has been stripped from ink particles and is introduced into the bath again.

Thus, a cost reduction of cleaning fluid can be achieved.

According to a favourable embodiment, the cleaned band after being stripped from adhering cleaning fluid is subjected to a drying step.

The drying step may comprise the use of wiper blades, air knives and a drying chamber or a combination thereof.

Thus, the cleaned band can be stripped from adhering fluid even more effectively. The air knives are arranged such that they will blow air against the direction of travel of the cleaned band.

According to a favourable embodiment, after removal of the cleaning fluid the cleaned band will be rolled up.

Thus, it is ready to be printed on again, for instance for setting a printing process.

According to a favourable embodiment, the band obtained after removal of cleaning fluid by means of wiper blades is once again exposed to additional fluid on both sides.

The additional fluid is for instance cleaning fluid. Exposure may for instance take place by spraying or guiding the band through a second bath (also including a compartment of the earlier bath). This second bath contains for instance cleaning fluid as the additional fluid, which is relatively clean. This cleaning fluid may be brought, continuously or non-continuously, to the bath situated upstream from which subsequently fluid with a high level of ink is discharged. Thus, the pollution of cleaning fluid in the first bath is substantially less important, and the concentration thereof is allowed to reach higher levels. This provides for a cheaper discharge and/or easier filtering thereof. Furthermore, in this way the consumption of cleaning fluid can be reduced whereas an excellent cleaning is achieved.

After exposure to the additional fluid the cleaned band is again stripped from adhering fluid by means of additional wiper blades.

According to a favourable embodiment, the additional fluid is at least 96 v/v. % water, preferably 98.5 v/v. % water and more preferably 99.8 v/v. % water.

Thus, a better drying is achieved because less low volatile components will be present and thus a faster/better drying can be achieved and/or after drying less chemicals will remain on the resulting film.

Preferably, the additional fluid is calcium depleted water such as descaled water, demineralised water, reverse osmosis water or distilled water.

According to a favourable embodiment, wiper blades selected from a pair of wiper blades and/or from a pair of additional wiper blades are at a location where the band moves at an angle of at least 20° with the horizontal and for each pair the wiper blades of each pair are arranged in the direction of transport at a distance of at least 2 cm from one another and protrude to beyond the band, wherein the band is first passed over the uppermost wiper blade and subsequently over the lowermost wiper blade of a pair.

Thus, cleaning fluid can be be removed from the film more effectively. For the first pair of wiper blades this also implies that in this way pollution of a second bath, situated with respect to the band downstream from the first pair of wiper blades, is delayed more effectively.

The distance in the direction of transport of the wiper blades and/or additional wiper blades is preferably at least 2 cm and more preferably at least 4 cm (this distance is the distance between the contact lines of the wipers of a pair with the film). A larger distance may avoid problems such as one or more of i) stretching of the band, ii) pleating, and iii) tearing of the band whereas nevertheless fluid on the particular surface of the band can be removed in a highly effective way. The angle with the horizontal is preferably at least 40°.

According to a favourable embodiment, the wiper blades selected from wiper blades and/or from additional wiper blades are situated at a location where the band is fed between the wiper blades at an angle of at most 87°, preferably at most 82°, and more preferably at most 75° with the horizontal.

In this way the likelihood is reduced that the wiper blade brings fluid from one side of the band to the other side. Thus, at both sides of the band fluid is removed from the band effectively.

Finally, the present invention relates to device for cleaning a printed band, which apparatus
comprises a frame,
comprises a motor for feeding the printed band through the apparatus, and
comprises a cleaning organ for removing printing ink from the printed band;
   wherein the apparatus comprises an auxiliary frame, which auxiliary frame
comprises at least one guide roll in order to determine a path for the printed band; and
   the apparatus is arranged in order to allow the auxiliary frame
to be in a relatively high first position, and
a relatively low second position.

Thus, prior to cleaning the printed band, the printed band can be brought in the first position in the auxiliary frame, and for cleaning the auxiliary frame be brought in the second position wherein the printed band is fed through a bath of cleaning fluid. The invention also relates to any embodiment in any combination as described in the dependent method claims, which only for the sake of briefness will not be repeated.

According to a favourable embodiment, the auxiliary frame comprises the cleaning organ.

Thus, the arrangement of the auxiliary frame in the bath is less critical, and the printed band can be cleaned effectively with increased reliability. The cleaning organ, such as a scraping organ, can preferably be displaced and fixed with respect to the auxiliary frame.

According to a favourable embodiment, at any from i) a first side of the auxiliary frame, and ii) an opposite second side of the auxiliary frame, at least one flexible member is provided which
is passed over a suspension point, and
comprises a section that extends downwardly;
   and the auxiliary frame can be moved from the second position to the first position by exerting a downward force onto said sections.

Thus, the height of the apparatus at the location of the auxiliary frame can be kept limited. More specifically, no hoist is required that protrudes to beyond the top of the auxiliary frame in the first position thereof. An additional advantage is the improved accessibility around the auxiliary frame, whereby a printed band can be brought into the auxiliary frame more easily when this is in the first position for cleaning said printed band. The flexible member will preferably be attached at the lowermost half of the auxiliary frame, advantageously at less than 25% of the height thereof. Hereby, the upper side of the auxiliary frame can protrude to beyond the top of the suspension points and the printed band can be brought in the auxiliary frame easily. Most preferably, a flexible member is attached near every corner of the auxiliary frame. The flexible member is for instance a chain, a gear belt, a belt or a cable. The suspension point is advantageously shaped as a gear wheel or a pulley. In order to evenly hoist the auxiliary frame the flexible elements are preferably coupled. Advantageously, cables are wound up around an axle, more advantageously around an axle having an exterior thread; wherein through rotation of the axle the axle is displaced longitudinally. The latter can be simply achieved by installing the axle rotatably in a through-hole having an internal thread. Hereby also changes in angle of the flexible elements are avoided, and a very even lifting of the auxiliary frame can be achieved.

According to a favourable embodiment, the apparatus comprises a support for a bath of cleaning fluid, wherein the flexible elements that run toward the opposite second side extend under the support.

Thus, the bath can be removed without being hindered by the auxiliary frame and the construction for guiding it to the first position thereof. The support is advantageously in the form of rails, for instance in the form of troughs in which the wheels of a mobile bath are led, in order to be able to easily position the bath, whereby the auxiliary frame can be brought to the second position without hindrance.

The present invention will now be illustrated with reference to the drawing where

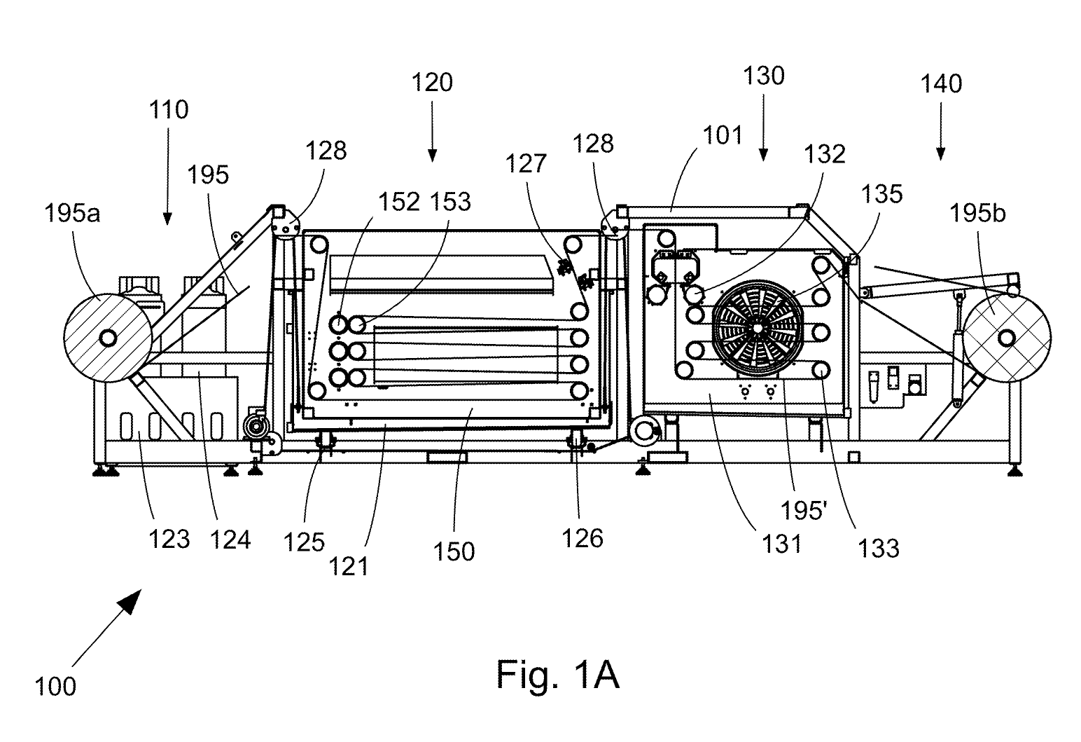

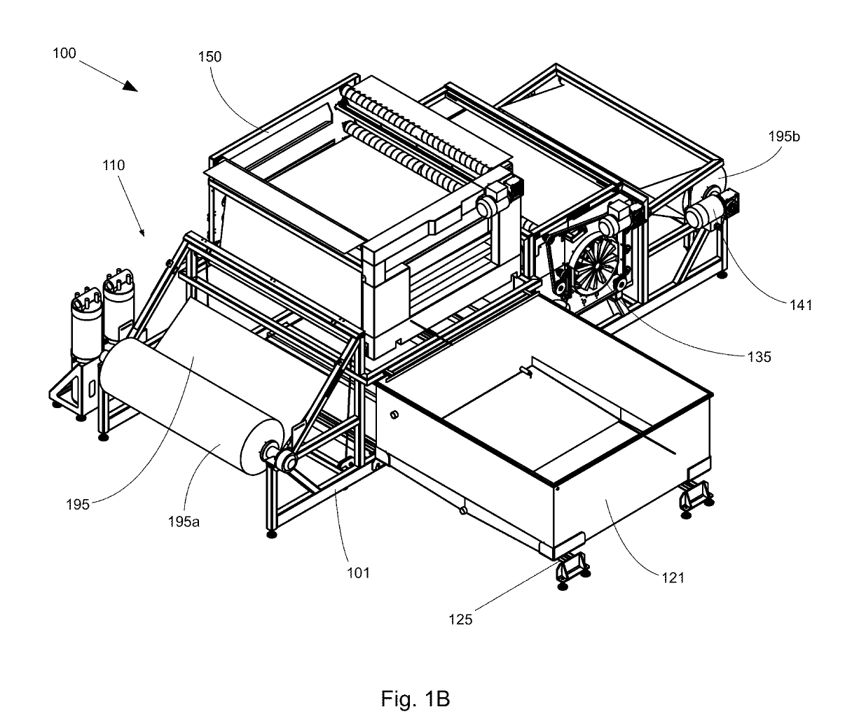

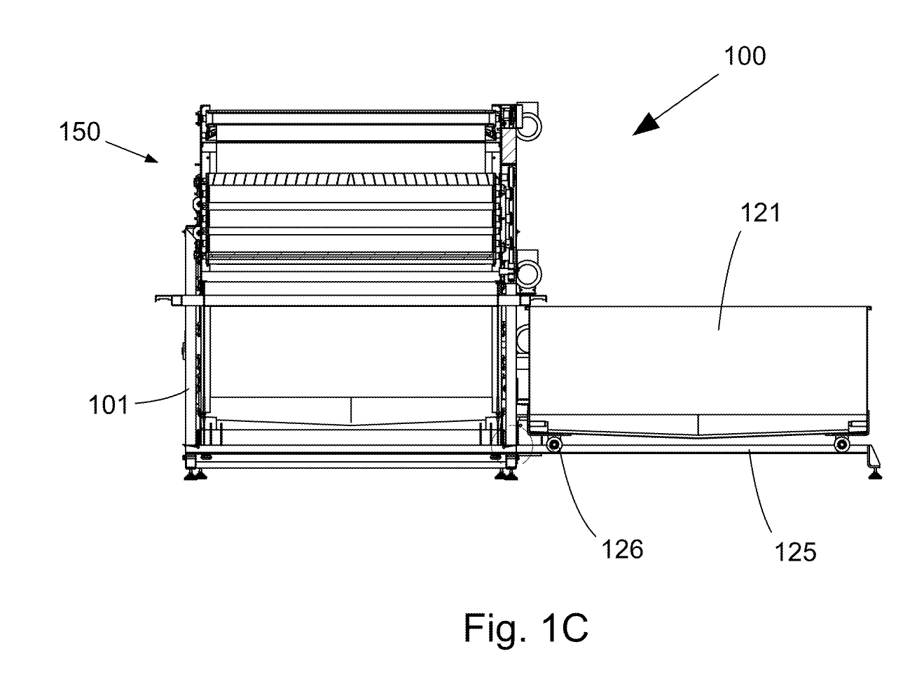

FIG. 1a shows a longitudinal sectional view through a apparatus according to the invention;

FIG. 1b shows a perspective view of the apparatus according to FIG. 1A in a state wherein the apparatus is provided with a band of film;

FIG. 1c shows a cross-section through the apparatus of FIG. 1B;

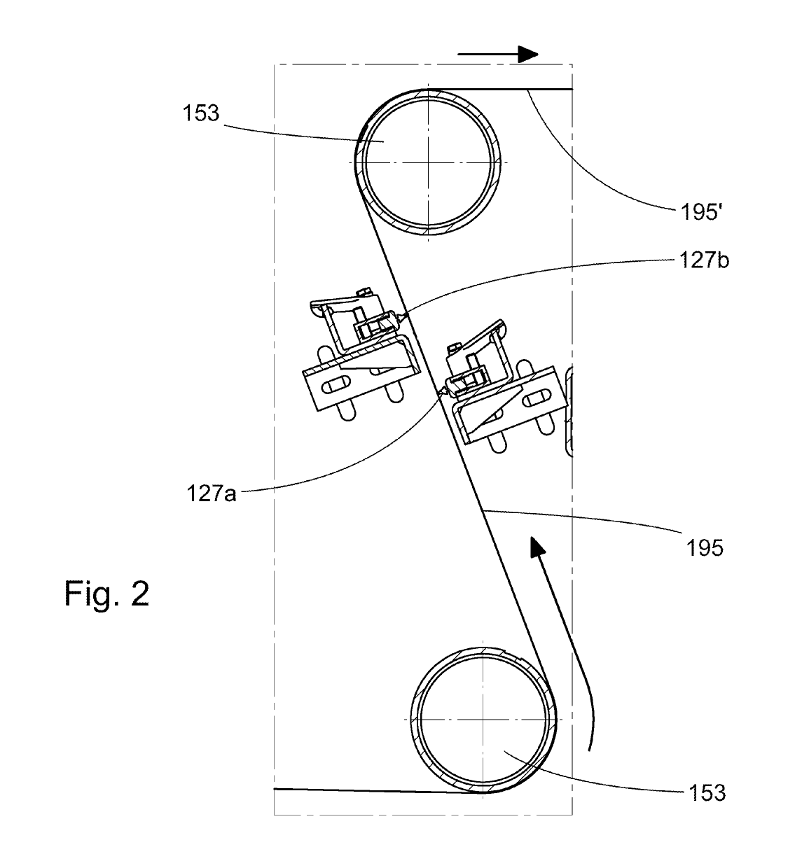

FIG. 2 shows a detail of wiper blades of the apparatus of FIG. 1A;

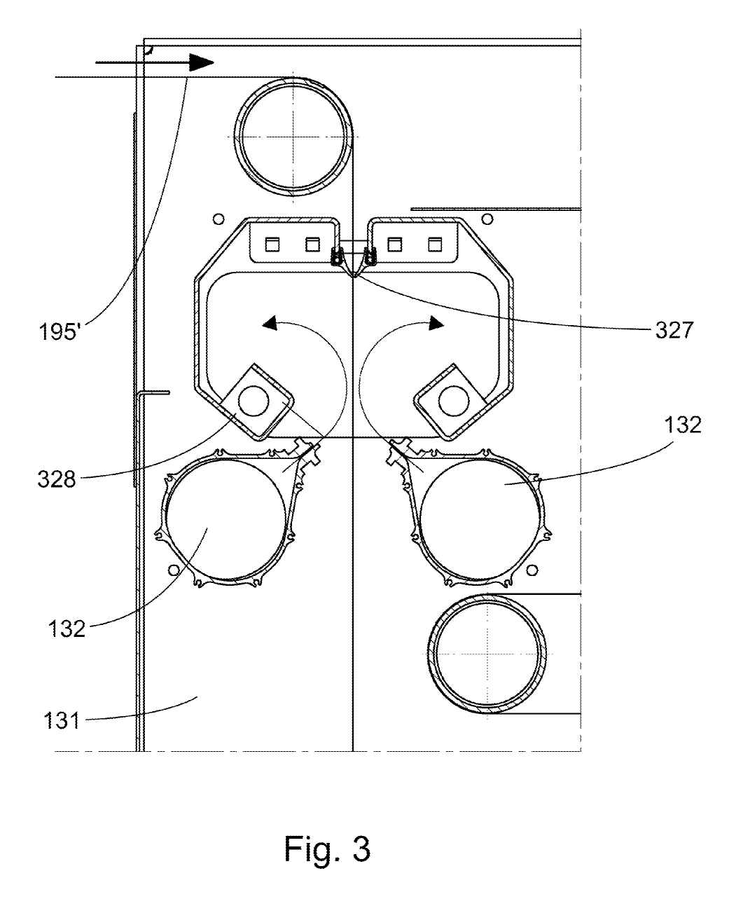

FIG. 3 shows a detail of a drying chamber of the apparatus of FIG. 1A;

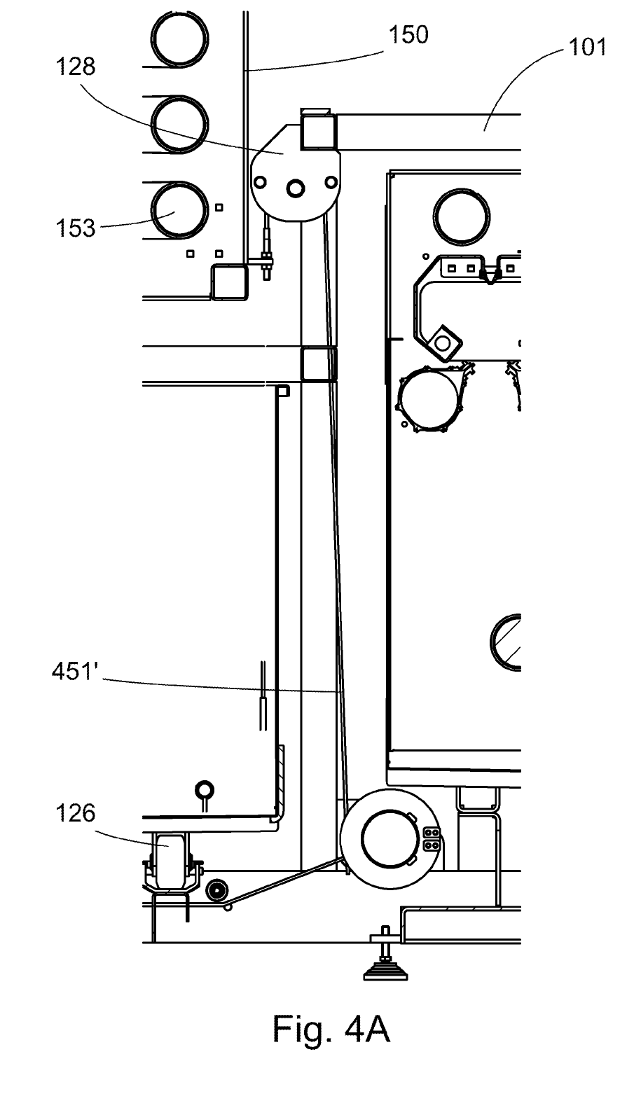

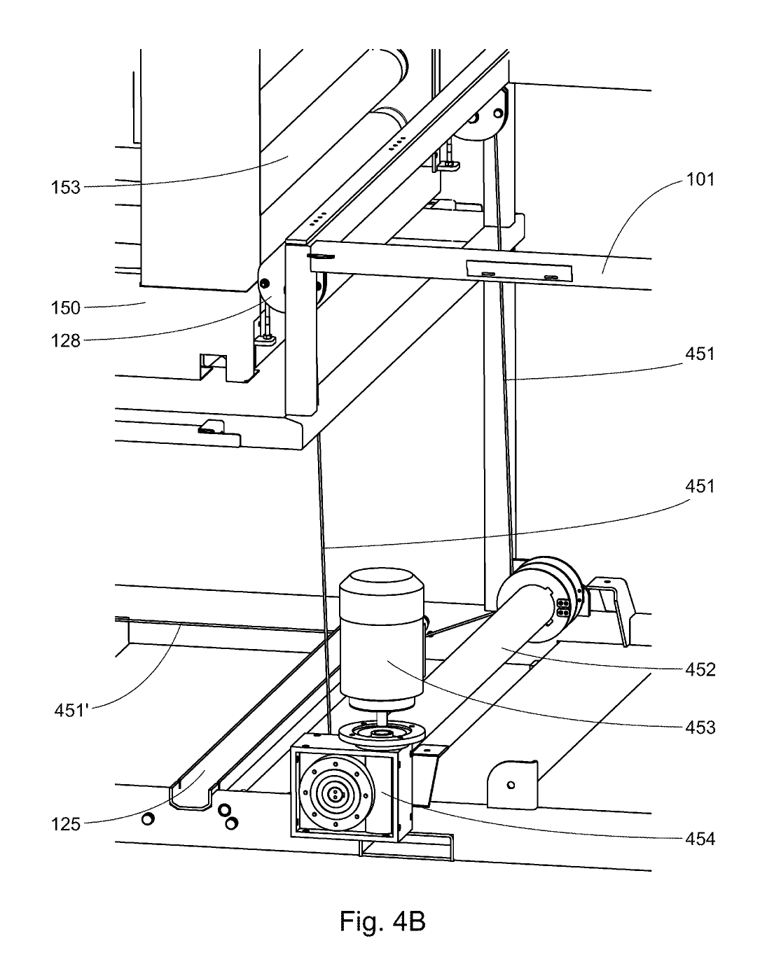

FIG. 4A shows a detail of the longitudinal sectional view of FIG. 1A;

FIG. 4b shows a perspective view of the detail of FIG. 4A;

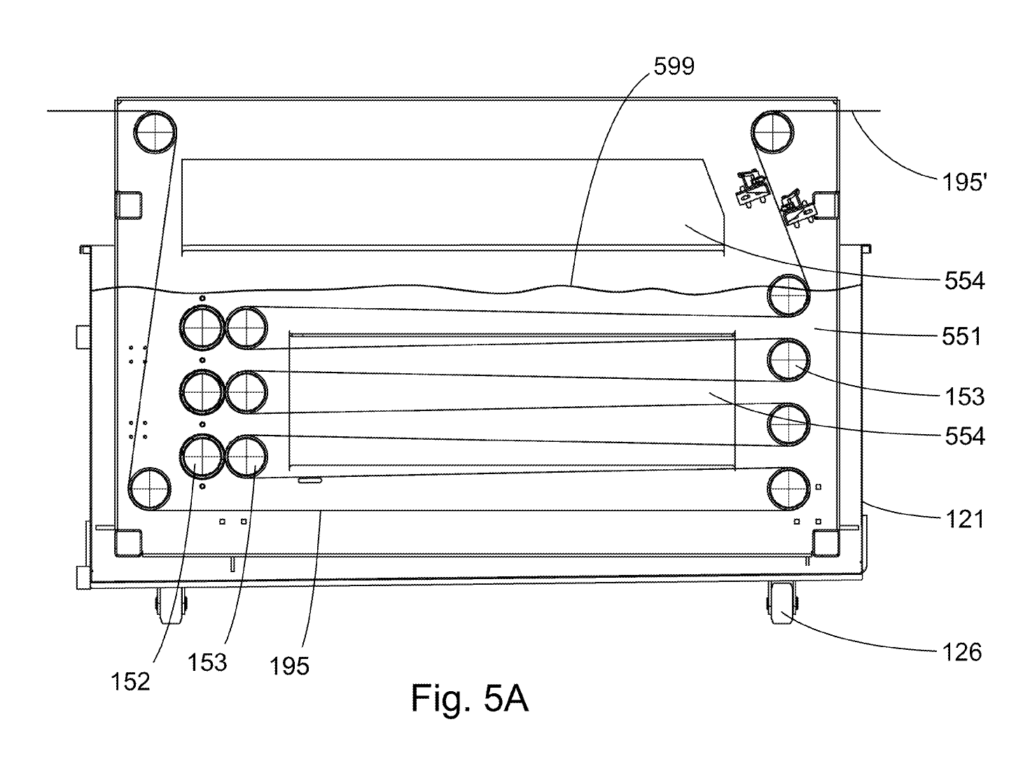

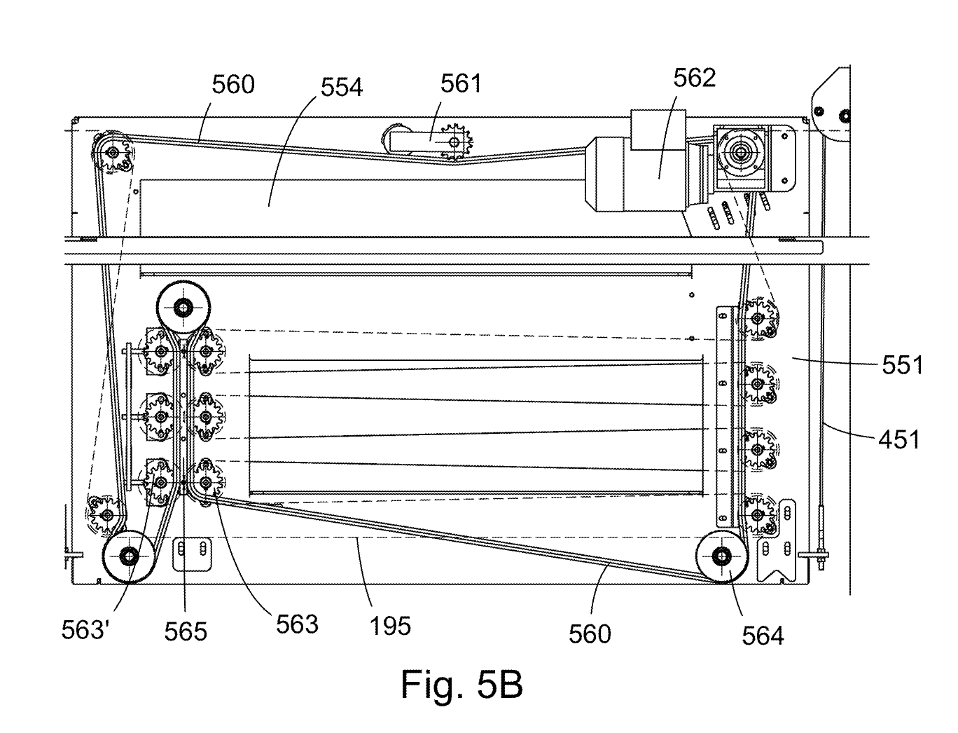

FIG. 5a shows a detail in longitudinal sectional view of a bath of the apparatus according to the invention;

FIG. 5b corresponds with FIG. 5A and shows the actuation of brush rollers in the bath of the apparatus according to the invention;

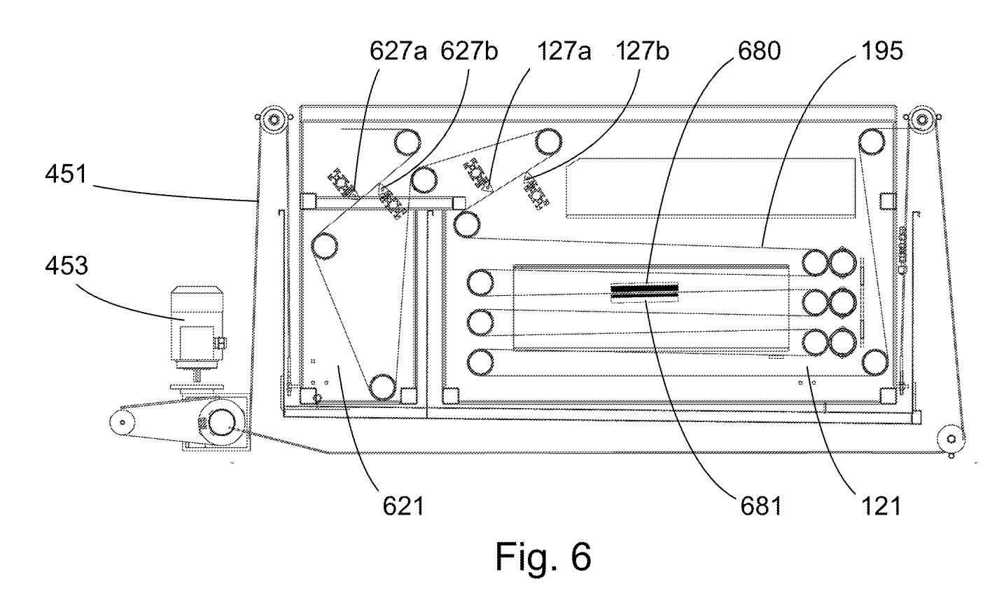

FIG. 6 shows a detail in longitudinal sectional view of a bath of an alternative apparatus according to the invention; and

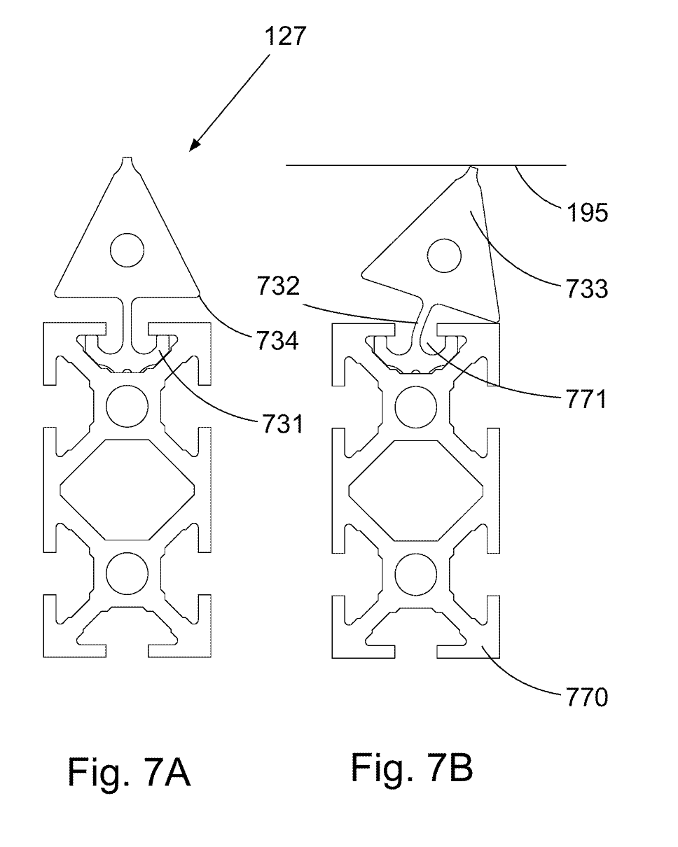

FIG. 7A and FIG. 7B show a cross section through a profile provided with a wiper blade in a first position of rest and a second position of use.

FIG. 1A-1C show a device 100 according to the invention for cleaning a printed band 195 of flexible material, in short film 195.

With the embodiment described here the device 100 comprises a first section 110 for feeding the film 195 to a second section 120 which is a cleaning section 120 and comprises a bath 121 that can be filled with a cleaning fluid. After the cleaning in the bath 121, the film 195 that has been stripped from printing ink is dried in a third section 130 and subsequently rolled up in a fourth section 140 yielding a roll 195b of cleaned film 195′ which is suitable for use when setting up the printing parameters when printing film.

More specifically, the device 100 comprises a frame 101. In the first section 110 the frame 101 is arranged for rotatably placing a roll 195a of printed film 195 that has to be stripped from printing ink.

Apart from the bath 121, the second section 120 comprises an auxiliary frame 150 which can be in a relatively high first position (FIG. 1B and FIG. 1C) and in a relatively low second position (FIG. 1A) at which the auxiliary frame 150 is situated in the bath 121.

The auxiliary frame 150 is provided with guide rolls 153 and rotating scraping organs 152. The guide rolls 153 determine a path of the film 195 through the auxiliary frame 150 and thus also through the bath 121. The rotating scraping organs 152 strip the printed film 195 from the printing ink, aided therewith by the cleaning fluid. Severed ink particles will end up in the cleaning fluid and can be transported by means of a pump 123 to a filter 124 after which the cleaned fluid ends up in the bath 121 again. The filter 124 is for instance a candle filter (Type VB-H-52, Firma Van Borselen, Zoetermeer, The Netherlands). The cleaning fluid is for instance Polywash 3000 (Polymount International BV, Nijkerk The Netherlands), a cleaning fluid based on 4-hydroxy-4-methylpentan-2-on. The scraping organs 152 are for instance rollers (diameter 8 cm) covered with nylon plush (Pental Eterna Brushes & Tools Making Co., Ltd., Shanghai, China). Advantageously the plush material is applied to the rollers in the shape of a band and in the shape of a spiral, thus enabling a more effective cleaning of the film 195.

When the film 195′ that has been stripped from printing ink exits the bath 121, there is adhering fluid on the surface of the film 195′. This will be removed by using a pair of conventional rubber wiper blades 127, that are positioned on either side of the film 195′ and press against the film 195′ that is fed between them. In order to effectively remove the adhering fluid, the wiper blades 127 protrude to beyond the band of film 195′. The wiper blades are preferably made of EPDM rubber.

The film 195′ is fed along the wiper blades at an angle of 55° with the horizontal, first past the wiper blade at the upper side at a distance 280 of 10 cm followed by a wiper blade at the lower side of the film 195′.

In the third section 130 the film 195′ is dried in a drying chamber 131 using air knives 132. The film 195′ is fed through the drying chamber 131 by a long path created by guide rolls 133, wherein air is fed to the drying chamber 131 by means of a fan 135. The dried film 195′ is rolled up in the fourth section 140. The roll 195b film 195′ is powered by means of a motor 141 and pulls the film 195 through the device 100.

FIG. 1A also shows pulleys 128 for moving the auxiliary frame 150 from the first position to the second position and vice versa. This will be further elucidated below with reference to FIG. 4A and FIG. 4B.

FIG. 1B shows a perspective view of the apparatus 100 of FIG. 1A, however in a state wherein the bath 121 has been rolled via rails 125 to outside the frame 101. This may e.g. be practical when cleaning the bath 121.

Furthermore, the auxiliary frame 150 is in the first relatively high position wherein the printed film 195 can readily be introduced in the auxiliary frame 150. Prior to cleaning the printed film 195, the bath 121 will be rolled under auxiliary frame 150, whereafter this will be brought toward the relatively low second position (FIG. 1A).

FIG. 1C shows a cross-sectional area through the apparatus 100 in the situation shown in FIG. 1B wherein the bath 121 which is provided with wheels 126 has been rolled over the rails 125 to outside the frame 101; and wherein the auxiliary frame 150 is in the relatively high first position.

FIG. 2 shows a detail of the apparatus of FIG. 1A, and in particular shows a pair of wiper blades 127, between which the band of film 195′ is fed when it exits the bath 121 with cleaning fluid. Thus, adhering cleaning fluid is removed from the band. Therewith however, the band of film 195′ is not yet completely dry and also residual drops may be present on the band of film 195′.

FIG. 3 shows a detail of the drying chamber 131 of the apparatus 100 of FIG. 1A. The band of film 195′ is now guided between two wiper blades 327, which also make sure that the band of film 195′ is guided between two air knives 132. The air knives 132 both block any drops of fluid and enhance the evaporation thereof. The wiper blades 327 in particular make sure that drops that are blown off the film by the air knives 132 do not end up on the film again but are guided away from the film toward troughs 328 for discharge of the removed fluid.

For moving the auxiliary frame 150 from the first position towards the second position thereof v.v., with the embodiment of the apparatus according to the invention discussed here, the auxiliary frame 150 is at the lowermost section (half) thereof provided with flexible elements 451, here in the form of cables 451. The cables 451 are attached to an axle 452 (FIG. 4B) which can be powered by a motor 453 having a right-angled transmission 454. Thereby the cables 451 are wound up on or wound off of the axle. The cables 451 are guided over pulleys 128. In this way the auxiliary frame 150 can be lifted simply and reliably (toward the first position) or it can be lowered again.

FIG. 4A reveals that the cables 451′ for the opposite side of the auxiliary frame extend under the rails 125.

FIG. 5A shows a longitudinal sectional view through the bath 121 and the auxiliary frame 150 and illustrates how the printed band 195 for cleaning thereof is fed through the bath 121 of cleaning fluid 599 using guiding rolls 133.

With the present embodiment the auxiliary frame 150 comprises two parallel steel plates 551 which are provided with windows 554 for inserting the printed band 195 in the auxiliary frame 150 when this is in the relatively high first position.

FIG. 5B essentially corresponds with FIG. 5A, and illustrates the cleaning of the printed band 195 by means of guiding rolls 153 and the scraping organs 152 powered by a chain 560 provided with a chain tightener 561, guiding wheels 564, and a drive motor 562. To this end the guiding rolls 153 and the scraping organs 152 are provided with gear wheels 563, 563′ that are set in rotation by the chain 560. With the embodiment described here, the drive motor 562 is governed depending on the velocity with which the motor 141 transports the band through the apparatus.

With the embodiment described here, the scraping organs 152 have been displaceably installed in a horizontal direction, and they press against the printed band 195. The gear wheels 563′ of the scraping organs 152 press the chain 560 via a Teflon® plastic strip 565 against gear wheels 563 of the guiding rolls 153. More specifically the plastic strip 565 is present between the plates and against the pins of the links of the chain 560. Hereby the chain 560 effectively drives the gear wheels and the chain will not disengage from the gear wheels.

FIG. 6 largely corresponds with FIG. 5A, except that a second bath 621 is provided with an additional fluid. Additional wiper blades 627 placed downstream will hardly get dirty and clean film 195′ can be obtained in a highly effective way.

The additional fluid of the second bath 621 will stay relatively clean and in case it is cleaning fluid it can be discharged in the first bath 121. This can be done continuously or batch wise.

Advantageously, the additional fluid of the final bath however is clean water, thus leaving less chemicals on the film.

With this embodiment the wiper blades 127a, 127b and additional wiper blades 627a, 627b are placed in the direction of transport of the film 195 for each pair at a distance of 10 cm of each other, which offers the advantage of being able to exert a relatively larger force on the film, as a result of which it can be stripped from adhering fluid effectively, yielding a qualitatively better, cleaner film 195′.

Both pairs of wiper blades are preferably situated at a location where the film is at an angle of at least 40° with the horizontal, as a result of which gravity helps with a quick discharge of the particular fluid. The wiper blade 127a that strips the film at the upper side thereof from fluid is preferably positioned upstream with respect to the wiper blade that strips the underside from fluid. Thus, fluid flowing from the side of the upper side of the film toward the underside of the film can still be removed by the wiper blade 127b situated (but with the contacting edge thereof higher) downstream (the same applies for the additional wiper blade 627b).

FIG. 6 also shows an alternative cleaning organ in the form of a brush plate 680. In order to be able to effectively exert force on the film 195 a counter plate 681 is provided at the opposite side. In order to prevent damage to the film 195 this counter plate 681 may be provided with relatively short, relatively flexible brush hairs whereas the brush plate 680 is provided with relatively long, relatively inflexible brush hairs.

FIG. 7A and FIG. 7B show a cross section through a profile 770 which comprises a longitudinal groove 771 in which a wiper blade 127 is received, in particular a base section 731 which is connected via a flexible but dimensionally stable neck section 732 with the wiper section 733.

When in use the wiper section 733 will be carried along by the film 195 against which the wiper blade 127 is pressed causing the wiper section 733 to tilt until the wiper section 733 with a longitudinal edge 734 thereof gets into contact with profile 770. Thus a fixed angle of the wiper section 733 with respect to the film 195 is achieved.

This embodiment allows the film 195 to be fed from the other side, which may be necessary when the band of film 195 has to be coupled to a following band of film 195.

Within the scope of the claims as defined the method and apparatus can be varied in various ways by the appended claims. For example, in order to remove printing ink at an opposite side of the printed band an additional scraping organ may be provided, such as in FIG. 5A with the guiding rolls at the right.

1. Method for cleaning a printed band of flexible material, wherein the band comprises printing ink at at least one side thereof and is stripped from the printing ink using an apparatus for cleaning the printed band of flexible material, which apparatus comprises a cleaning organ, and
which method comprises the steps of
contacting the at least one side of the band that comprises printing ink with a cleaning fluid,
removing the printing ink that has been contacted with the cleaning fluid with the cleaning organ yielding a cleaned band of flexible material, and
removing adhering cleaning fluid from the cleaned band of flexible material;
characterized in that the printed band
is guided into a bath of cleaning fluid, and
is stripped from the printing ink in the bath by means of the cleaning organ yielding the cleaned band; and
the cleaned band is guided from the bath and is stripped from the adhering cleaning fluid.

2. Method according to claim 1, wherein the cleaning organ is a rotating scraping organ which rotates with a velocity that is coupled to the velocity with which the cleaned band exits the bath.

3. Method according to claim 2, wherein the direction of rotation of the rotating scraping organ is such that, at the location where the scraping organ is in contact with the printed band, it rotates against the direction of travel of the printed band.

4. Method according to claim 1, wherein the printed band is cleaned with an apparatus comprising a frame and an auxiliary frame, which auxiliary frame
comprises at least one guide roll;
can be in a relatively high first position and a relatively low second position;
wherein for cleaning the printed band
the printed band in the first position is introduced into the auxiliary frame, and
the auxiliary frame is put into the second position and the printed band, for the cleaning thereof, is fed through the auxiliary frame.

5. Method according to claim 4, wherein the auxiliary frame comprises the cleaning organ.

6. Method according to claim 1, wherein the cleaning fluid in the bath is subjected to a filtration in order to remove ink particles.

7. Method according to claim 1, wherein the cleaning fluid in the bath is subjected to a distillation in order to obtain a cleaning fluid that has been stripped from ink particles and is introduced into the bath again.

8. Method according to claim 1, wherein the cleaned band after being stripped from adhering cleaning fluid is subjected to a drying step.

9. Method according to claim 1, wherein after removal of the cleaning fluid the cleaned band will be rolled up.

10. Method according to claim 1, wherein the band obtained after removal of cleaning fluid by means of wiper blades is once again exposed to additional fluid on both sides.

11. Method according to claim 10, wherein the additional fluid is at least 96 v/v. % water.

12. Method according to claim 1, wherein wiper blades selected from a pair of wiper blades and/or from a pair of additional wiper blades are at a location where the band moves at an angle of at least 20° with the horizontal and for each pair the wiper blades of each pair are arranged in the direction of transport at a distance of at least 2 cm from one another and protrude to beyond the band, wherein the band is first passed over the uppermost wiper blade and subsequently over the lowermost wiper blade of a pair.

13. Method according to claim 12, wherein the wiper blades selected from wiper blades and/or from additional wiper blades are situated at a location where the band is fed between the wiper blades at an angle of at most 87°.

14. Device for cleaning a printed band, which apparatus
comprises a frame,
comprises a motor for feeding the printed band through the apparatus, and
comprises a cleaning organ for removing printing ink from the printed band;
characterized in that the apparatus comprises an auxiliary frame, which auxiliary frame
comprises at least one guide roll in order to determine a path for the printed band; and
the apparatus is arranged in order to allow the auxiliary frame to be in a relatively high first position, and a relatively low second position.

15. Device according to claim 14, wherein the auxiliary frame comprises the cleaning organ.

16. Device according to claim 14, wherein at any from i) a first side of the auxiliary frame, and ii) an opposite second side of the auxiliary frame, at least one flexible member is provided which
is passed over a suspension point, and
comprises a section that extends downwardly;
and the auxiliary frame can be moved from the second position to the first position by exerting a downward force onto said sections.

17. Device according to claim 14, wherein the apparatus comprises a support for a bath of cleaning fluid, wherein the flexible elements that run toward the opposite second side extend under the support.
